(19) United States
(12) Patent Application Publication
(10) Pub. No.: US 2008/0028959 A1
(43) Pub. Date: Feb. 7, 2008

(54) Variable printing machine

(75) Inventors: Masahiro Naka, Narashino-shi (JP); Reishi Fujiwara, Daisen-city (JP)

Correspondence Address: COHEN, PONTANI, LIEBERMAN & PAVANE, 551 FIFTH AVENUE, SUITE 1210, NEW YORK, NY, 10176, US

(73) Assignee: Miyakoski Printing Machinery Co., Ltd., Narashino-shi (JP)

(21) Appl. No.: 11/888,364

(22) Filed: Jul. 31, 2007

(30) Foreign Application Priority Data
Aug. 1, 2006 (JP) JP 209581/2006

(51) Int. Cl. B41F 13/02

(52) U.S. Cl. 101/228

(57) ABSTRACT

To make it possible to variably print while preventing a printable material from loosening and fluttering and further preventing the material from damaging and contamination by printing. To this end, an impression cylinder 6 in a printing unit 3a-3d disposed between a pair of feed rollers 1, 2 is adapted to be driven to rotate synchronously with the feed rollers, and there are further provided: a guide roller 14a, 14b at least at one of upstream and down-stream sides of impression cylinder 6 by which the printing material to pass between printing cylinder 5 and impression cylinders 6 is wound at a certain angle of winding on impression cylinder 6; on impression cylinder 6 a timing and a V pulley 15, 16 which are identical in pitch circle diameter to each other; and on guide roller 14a, 14b a timing and a V pulley 17a, 17b and 18a, 18b which are identical in pitch circle diameter to each other; wherein the timing and V pulleys provided on said impression cylinder and those provided on the guide roller have a ratio between their pitch circle diameters which is identical to a ratio between the outer diameters of the impression cylinder and guide roller means; and a timing belt 22 and a V belt 23 are adapted to be wound on the timing pulleys and the V pulleys, respectively.

### BACKGROUND OF THE INVENTION

1. Technical Field

The present invention relates to a variable printing machine.

2. Description of the Prior Art

A variable printing machine of offset type is constructed as shown in FIG. 1. A plurality of variable printing units 3a, 3b are horizontally arranged between a pair of rollers 1 and 2 made synchronously rotatable normally and reversely. And, each of the printing units 3a, 3b comprises a printing, a blanket and an impression cylinder 4, 5 and 6. The blanket cylinder 5 is formed with a larger diameter section providing a printing surface having, e.g., a peripheral length s-a that is ½ of the outer periphery of the blanket cylinder, the larger diameter section having a blanket 7 laid on its peripheral surface.

On the other hand, the printing cylinder 4 is fitted on a portion to be engaged with the larger diameter section of the blanket cylinder 5 with a printing plate 8 having a peripheral length that is shorter than the peripheral length s-a. And, the printing plate 8 of the printing cylinder 4 is supplied with ink from an inking unit (not shown) provided adjacent to the printing cylinder 4. Further, a paper buffering section 9 (looped section) is provided at least at one of the upstream side of the upstream side feed roller and the down-stream side of the downstream side feed roller, of the pair of feed rollers 1 and 2 (see, e.g., JP H02-75561 A).

In this variable printing machine, while the blanket cylinder 5 is being continuously rotated, a print of a top-bottom length equal to a peripheral length s-b shorter than the peripheral length of the larger diameter section of the blanket cylinder 5 is made repeatedly in the top-bottom direction and continuously on continuous paper 10 in such a manner that: the feed rollers 1 and 2 act to move continuous paper 10 forward to travel at uniform rate over the peripheral length s-a of the larger diameter section of the blanket cylinder 5 and then while peripheral length a-s of the smaller diameter section of the blanket cylinder 5 in each printing unit 3a, 3b is opposed to the impression cylinder 6, namely in a so-called escaping interval, to move continuous paper 10 backward by length a-b corresponding to non-image bounds to be secured on continuous paper; these movements in succession are repeated so that an image of top-bottom length s-b can be printed for one rotation of the blanket cylinder 5 in each printing unit 3a, 3b, and such images printed reiteratively and leaving no extra space between them, on continuous paper 10.

In a variable printing machine of this type, the run-through path for continuous paper 10 between the two feed rollers 1 and 2 is in a straight line as shown in FIG. 1 with no guide roller provided on the upstream or downstream side of each printing unit 3a, 3b. As a result, in the step of moving continuous paper 10 backward in which continuous paper 10 is opposed to the smaller diameter section of the blanket cylinder 5, continuous paper 10 in the path between the two rollers 1 and 2 is placed in the state that it is not nipped momentarily over its entire length, and this is repeated for each printing.

Consequently, in the conventional variable printing machines of this type, its fluttering has been apt to be produced in continuous paper in the path of travel between the two feed rollers 1 and 2. And, especially in a center region of its travel path, continuous paper has tended to become loosened and fluttered and its tension to become unstable, causing continuous paper to meander.

It has thus been considered necessary to provide a difference in peripheral speed between the upstream and downstream side rollers 1 and 2 to intensify the tension on continuous paper 10 and thereby to get rid of its loosening and fluttering due to its own weight to repress the meandering while preventing paper 10 from contaminating and damaging by its contact with the blanket and impression cylinders 5 and 6.

However, if plastic film is used as the continuous paper or material to be printed, such material is easily damaged and easy to stick to the cylinders by static electricity so that it can hardly be prevented from damaging and contaminating by its rubbing against the impression or blanket cylinder.

Further, where the material to be printed, irrespective of paper or film, is thin and its path of travel between the two feed rollers reaches as long as 7 m or more, intensifying tension on the material to repress the loosening and fluttering in-between gives rise to different problems on its elongation and cutting; hence it is not possible to raise the tension and to prevent the meandering.

With these problems taken into account, it is an object of the present invention to provide a variable printing machine which where the material to be printed is plastic or thin material, makes it possible to print it smoothly while preventing it from loosening or fluttering and moreover is capable of operation with an increased stability of its traveling behavior and capable of silent and stable operation even where the material is traveling at an increase speed.

### SUMMARY OF THE INVENTION

In order to achieve the object mentioned above there is provided in accordance with the present invention a variable printing machine having a pair of feed rollers synchronously rotatable normally and reversely and at least one printing unit arranged between the feed rollers wherein the printing unit includes a printing and an impression cylinder continuously rotatable while passing between them printable continuous material fed by the feed rollers to travel, and the printing cylinder is formed on its periphery with a larger diameter section adapted for contact with the printable material between the printing and impression cylinders to print on the printable material and a smaller diameter section not contactable with the printable material whereby the feed rollers act to cause the printable material to travel at a speed equal to a speed of rotation of the larger diameter section while the larger diameter section of the printing cylinder is in contact with the printable material and then to cause the printable material to travel reversely by a portion corresponding to non-image bounds in the larger diameter section of the printing cylinder while the smaller diameter section is opposed to the printable material, characterized in that:

the impression cylinder in the printing unit is adapted be driven to rotate synchronously with the pair of feed rollers; and

there are further provided:

guide roller means at least at one of upstream and down-stream sides of the impression cylinder by which the printing material to pass between the printing cylinder and impression cylinders is wound at a certain angle of winding on the impression cylinder;

on the impression cylinder a timing and a V pulley which are identical in pitch circle diameter to each other and on the guide roller means a timing and a V pulley which are identical in pitch circle diameter to each other, wherein the timing and V pulleys provided on the impression cylinder and those provided on the guide roller means have a ratio between their pitch circle diameters which is identical to a ratio between the outer diameters of the impression cylinder and the guide roller means; and

a timing belt and a V belt adapted to be wound on the timing pulleys and the V pulleys, respectively, and driven to rotate the guide roller means at a peripheral speed identical to that of, and synchronously with, the impression cylinder.

According to the makeup mentioned above, the printable material traveling between the upstream and downstream side feed rollers remains wound at a certain angle of winding by the guide roller continually on the impression cylinder means in each printing unit whereby when the larger diameter section of the blanket cylinder comes off the impression cylinder, giving rise to the state that the printable material is not under a nipping action by the blanket cylinder, the printable material then without becoming freed between the two feed rollers is prevented from loosening or fluttering while repeating reciprocal travel for variable printing.

And, especially according to this makeup, the guide roller means and impression cylinder are coupled together doubly by the timing and V belts whereby if a momentary slip is brought about in the timing belt due to its backlash with one or more of the timing pulleys affected by an impact force which develops each time the direction of rotation of the impression cylinder is switched, then such a slip can be hindered, absorbed and relieved by a frictional driving force by the V belt for coupling, thereby permitting the guide roller means to follow the rotation of the impression cylinder without causing a difference in speed of rotation between them. Since the printable material wound by the guide roller means on the impression cylinder is thus prevented from flattering while in reciprocating travel, the printable material is stabilized in traveling behavior and, if fed to fast travel, allows the machine to operate silently and stably.

And, in the variable printing machine, it is preferable that in addition to the V pulleys provided together with the timing pulleys at one ends of the impression cylinder and guide roller means, further V pulleys be provided on the other ends of the impression cylinder and guide roller means, and a further V belt be wound on the further V pulleys.

According to this makeup, it is required that the impression cylinder and the guide roller means be coupled together via V belts at their respective opposite ends whereby the guide roller means is driven by the V belts at its opposite ends and even if fine in diameter can be rotated without twisting and while maintaining its parallelism to the cylinder so as to stably guide the printable paper that is wound on the impression cylinder and travels.

The present invention also provides a variable printing machine having a pair of feed rollers synchronously rotatable normally and reversely and at least one printing unit arranged between the feed rollers wherein the printing unit includes a printing and an impression cylinder continuously rotatable while passing between them printable continuous material fed by the feed rollers to travel, and the printing cylinder is formed on its periphery with a larger diameter section adapted for contact with the printable material between the printing and impression cylinders to print on the printable material and a smaller diameter section not contactable with the printable material whereby the feed rollers act to cause the printable material to travel at a speed equal to a speed of rotation of the larger diameter section while the larger diameter section of the printing cylinder is in contact with the printable material and then to cause the printable material to travel reversely by a portion corresponding to non-image bounds in the larger diameter section of the printing cylinder while the smaller diameter section is opposed to the printable material, characterized in that:

the impression cylinder in the printing unit is adapted to be driven to rotate synchronously with the pair of feed rollers; and

there are further provided:

guide roller means at least at one of upstream and down-stream sides of the impression cylinder by which the printing material to pass between the printing cylinder and impression cylinders is wound at a certain angle of winding on the impression cylinder; and

a motor means coupled individually to each of the impression cylinder and the guide roller means at one end thereof, the motor means having a motor whose rotation is controllable independently.

According to the makeup mentioned above, it is required that the impression cylinder and the guide roller means be individually rotated by respective motor means having motors driven with their rotations controllable independently whereby the impression cylinder and the guide roller means can be rotated synchronously by their individually controlled motors without causing a difference in speed of rotation between them.

Also, in the variable printing machine, it is preferable that the impression cylinder and the guide roller means have at their other ends V pulleys fastened thereto, respectively, whose ratio between their pitch circle diameters is identical to a ratio between the outer diameters of the impression cylinder and guide roller means and a V belt be wound on the V pulleys.

According to this makeup, it is required that the guide roller means be coupled to the impression cylinder via a V belt at the side opposite to its motor side whereby the guide roller means is allowed to rotate without twisting so as to permit the printable material to be guided stably.

Also, in the variable printing machine, it is preferable that all the guide roller means provided between the pair of feed rollers be adapted to be driven individually by respective motors whose rotation is controllable independently.

According to this makeup, the continuous printable material can be caused to travel in synchronism with the pair of feed rollers, using all guide rollers positioned between the two feed rollers; moreover, the peripheral speed of rotation of each of the guide rollers can individually be controlled.

### BRIEF DESCRIPTION OF THE DRAWINGS

In the drawings:

FIG. 1 is an explanatory view illustrating the diagrammatic makeup of a variable printing machine in the prior art;

FIG. 2 is an explanatory view illustrating the diagrammatic makeup of a variable printing machine according to one form of implementation of the present invention;

FIG. 3 is an explanatory view diagrammatically illustrating an exemplary drive system for a guide roller in the form of implementation of the present invention;

FIG. 4 is a front view diagrammatically illustrating the exemplary drive system for the guide roller in the form of implementation of the present invention;

FIG. 5 is a front view diagrammatically illustrating another exemplary drive system for the guide roller;

FIG. 6 is a front view diagrammatically illustrating still another exemplary drive system for the guide roller;

FIG. 7 is a cross sectional view illustrating a V pulley; and

FIG. 8 is a front view illustrating the V pulley.

### DESCRIPTION OF THE PREFERRED EMBODIMENTS

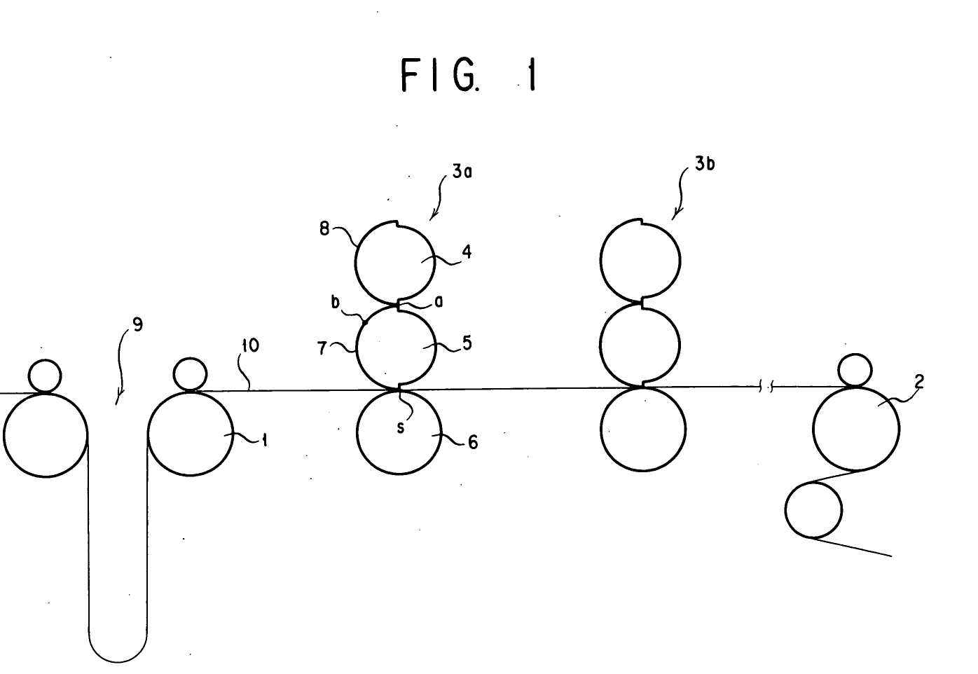

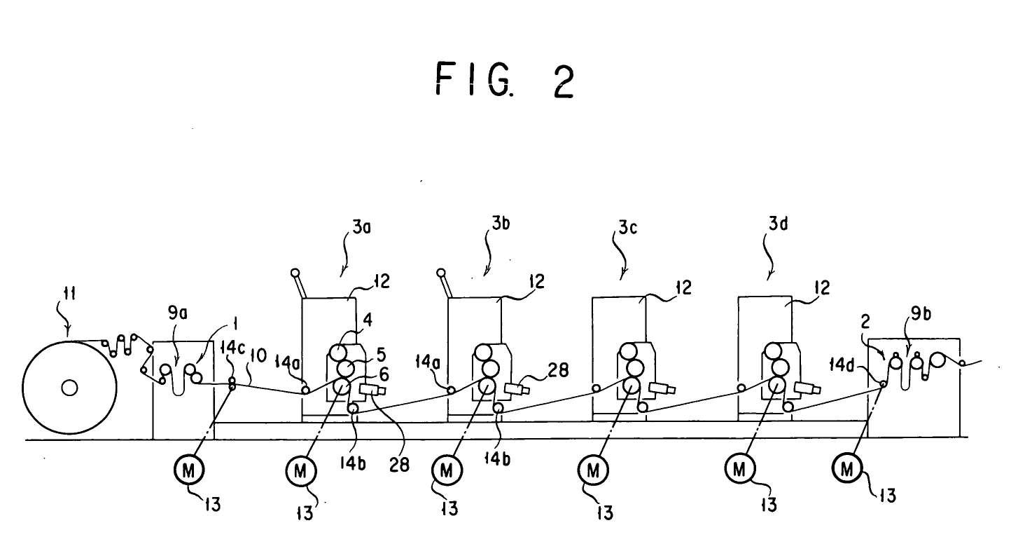

A variable printing machine according to the present invention is explained with reference to FIGS. 2 to 4, in which the same reference characters as in FIG. 1 showing the conventional makeup are used to designate the same components.

In the path of travel of continuous paper 10 between the upstream and downstream side rollers 1 and 2, a plurality of (here, four) printing units 3a, 3b, 3c and 3d each comprising a printing, a blanket and an impression cylinder 4, 5 and 6 and made capable of variable printing are shown arranged. The printing and blanket cylinders 4 and 5 in each printing unit 3a, 3b, 3c, 3d are designed to rotate at an identical peripheral speed. And, though not shown in FIG. 2, the printing cylinder 4 and the blanket cylinder 5 have a printing plate and a blanket fitted on the peripheries of their larger diameter sections, respectively. In addition, paper buffering sections 9a and 9b are arranged at the upstream side of the upstream side feed roller 1 and at the downstream side of the downstream side feed roller 2, respectively. Further, a paper supply 11 is disposed at the upstream side of the upstream paper buffering section 9a. Both the upstream and downstream side feed rollers 1 and 2 are coupled via a driving shaft to a single drive source or coupled to two independent motors whose rotations are controllable, respectively, so that they may rotate at an identical peripheral speed.

In the form of implementation shown in FIG. 2, the printing units 3a to 3d used are of exchangeable cylinder type, each of which as a three-cylinder type exchange cylinder unit comprising the printing, blanket and impression cylinders 4, 5 and 6 is removably fitted on a machine frame 12 for the printing units 3a to 3d. And, with the units so fitted, a driven gear provided for each printing cylinder 4 is meshed with a driving gear provided on each machine frame 12. Also, such driving gears provided on respective machine frames 12 are together coupled to a single prime mover on a main body of the printing machine so that the printing cylinders 4 in the printing units 3a to 3d may be rotated synchronously. Alternatively, the printing cylinders 4 may individually be driven by motors whose rotations are controllable independently.

And, in this form of implementation, the blanket and printing cylinders 5 and 4 in each exchange cylinder unit are coupled together but the impression cylinder 6 therein is rotationally driven by a motor whose rotation is controllable independently.

At the upstream and down stream sides of the impression cylinder 6 in each printing unit 3a, 3b, 3c, 3d there are arranged guide rollers 14a and 14b, respectively, by which continuous paper 10 to run between the blanket and impression cylinders 5 and 6 in each printing unit 3a, 3b, 3c. 3d is to be wound on the impression cylinder at a certain angle of winding.

Further, the guide rollers 14a and 14b while being coupled to the impression cylinder 6 in each printing unit 3a, 3b, 3c, 3d is designed to rotate at an identical peripheral speed of, and synchronously with, this impression cylinder 6.

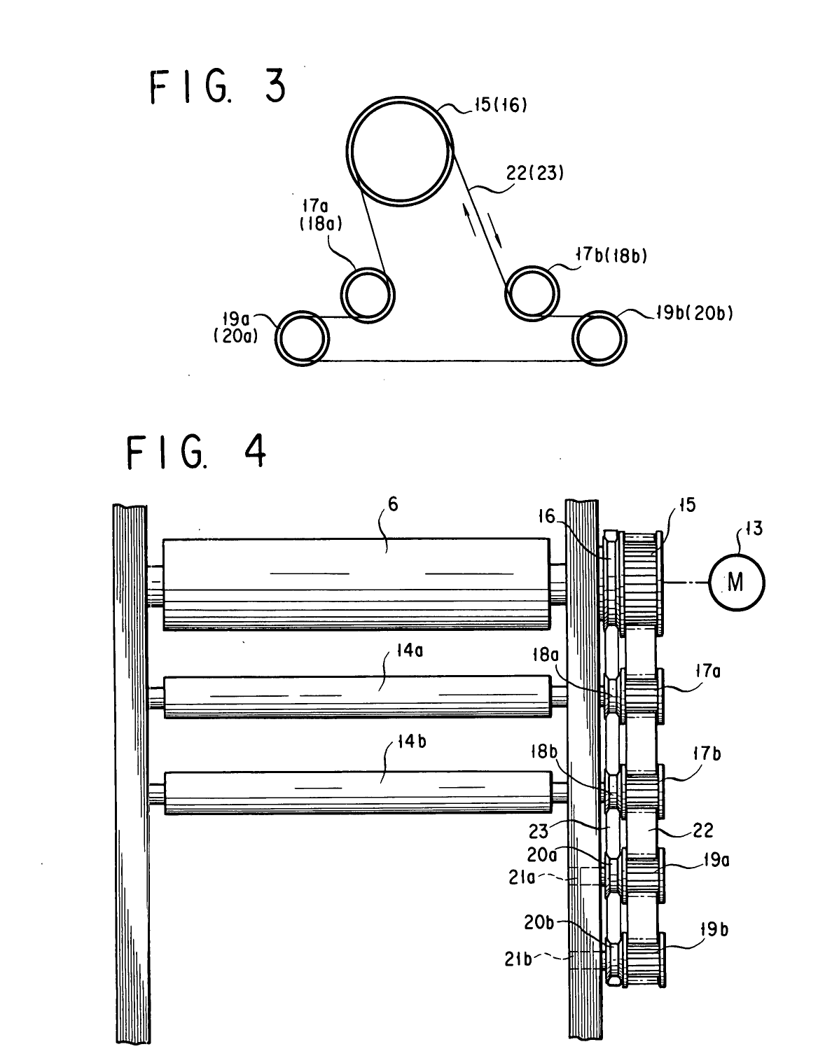

FIGS. 3 and 4 show an exemplary drive system for the guide rollers 14a and 14b. A driving timing pulley 15 and a driving V pulley 16 are fastened juxtaposed to each other at one end of the impression cylinder 6 driven by a motor 13, e.g., to an axial end on the motor 13 side.

Also, at respective one ends of the guide rollers 14a and 14b and at positions corresponding to the pulleys 15 and 16 for the impression cylinder 6, there are fastened driven timing pulleys 17a and 17b and driven V pulleys 18a and 18b so that the pulleys 17a and 17b are juxtaposed to the pulleys 18a and 18b, respectively. Further, spaced from and parallel to the guide rollers 14a and 14, there are provided tension timing pulleys 19a and 19b and tension V pulleys 20a and 20b so that the pulleys 19a and 19b are juxtaposed to the pulleys 20a and 20b, respectively and the pulleys 19a, 20a and pulleys 19b, 20b lie coaxially and rotatably with supporting shafts 21a and 21b, respectively, which are provided on the main machine body. And, at least one of the supporting shafts 21a and 21b, e.g., 21a are designed to be movable in position relative to the other, e.g., 21b, in a far and near direction.

A timing belt 22 of double faced type is wound on the driving timing pulley 15 provided for the impression cylinder 6, the driven timing pulleys 17a and 17b provided for the guide rollers 14a and 14b and both the tension timing pulleys 19a and 19b so that as shown in FIG. 3, its inner face engages the driving timing pulley 15 and both the tension timing pulleys 19a and 19b and its outer face engages the driven timing pulleys 17a and 17b.

Also, a V belt 23 of double faced type is wound on the driving V pulley 16 provided for the impression cylinder 6, the driven V pulleys 18a and 18b provided for the guide rollers 14a and 14b and both the tension V pulleys 20a and 20b so that as shown in FIG. 3, its inner face contacts the driving V pulley 16 and both the tension V pulleys 20a and 20b and its outer face contacts the driven V pulleys 18a and 18b.

The tension of the timing belt 22 and the V belt 23 is adjusted by shifting the position of one supporting shaft 21a to shift the position of the tension timing pulley 19a and the tension V pulley 20a which are supported by the shaft 21a.

The driving timing pulley 15 and the driving V pulley 16 which are provided for the impression cylinder 6 are made identical in pitch circle diameter to each other. The driven timing pulley 17a and the driven V pulley 18a which are provided for the guide roller 14a are made identical in pitch circle diameter to each other. Likewise, the driven timing pulley 17b and the driven V pulley 18b which are provided for the other guide roller 14b are made identical in pitch circle diameter to each other. And, the driving timing pulley 15 and the driving V pulley 16 provided for the impression cylinder 6, the driven timing pulley 17a and the driven V pulley 18a provided for the guide roller 14a, and the driven timing pulley 17b and the driven V pulley 18b provided for the other guide roller 14b have a ratio between their pitch circle diameters which is made identical to a ratio between the outer diameters of the impression cylinder 6, the guide roller 14a and the guide roller 14b. The guide rollers 14a and 14b are driven via the respective belts by the impression cylinder 6 to rotate at a peripheral speed which is identical to that of the impression cylinder 6.

The tension timing pulleys 19a and 19b respectively provided on the supporting shafts 21a and 21b are identical in pitch circle diameter to the tension V pulleys 20a and 20b, respectively.

With the makeup mentioned above, between the feed rollers 1 and 2 continuous paper 10 is passed between the respective blanket and impression cylinders 5 and 6 in the printing units 3a to 3d. Then, continuous paper 10 is wound on each impression cylinder 6 at a certain angle of winding via the guide roller 14a at its upstream side and the guide roller 14b at its downstream side.

Now, the feed rollers 1 and 2 and the impression cylinder 6 in each printing unit 3a, 3b, 3c, 3d are normally or reversely rotated, linked with an operation of the printing unit 3a, 3b, 3c, 3d. To wit, continuous paper 10 is fed normally to travel over a peripheral length of the larger diameter section of the blanket cylinder 5 in the printing unit 3a, 3b, 3c, 3d and fed reversely by an extra length of travel in the normal direction corresponding to non-image bounds.

Since the impression cylinder 6 and the guide rollers 14a and 14b are then controllably rotated at an identical peripheral speed and synchronously with a direction and a rate of travel of continuous paper 10, it follows that continuous paper 10 held wound on the impression cylinder 6 at the given angle is guided by the impression cylinder 6 to travel normally or reversely.

Thus, even during the time the smaller diameter section of the blanket cylinder 5 is opposed to the impression cylinder 6 in each printing unit 3a, 3b, 3c, 3d so continuous paper 10 is thus not nipped with the blanket cylinder 5, it follows that continuous paper 10 while held wound on the impression cylinder 6 is fed to travel reversely. Thus, continuous paper 10 is prevented from loosening or fluttering which has been experience when it is not under a nipping action by the blanket cylinder 5 whose smaller diameter portion is opposed thereto.

And then, since the guide rollers 14a and 14b which serve to guide continuous paper 10 ahead and behind each printing unit 3a, 3b, 3c, 3d are driven to rotate synchronously with, and at an identical peripheral speed to that of, the impression cylinder 6, continuous paper 10 is allowed to travel without slipping on the guide rollers 14a and 14b.

While operating as above, the guide rollers 14a and 14b provided at both sides in continuous paper traveling direction of the impression cylinder 6 are driven in a double drive system by the timing belt 22 and the V belt 23.

And, in this belt driving by the impression cylinder 6, between the driving timing pulley 15 for the impression cylinder 6 and the timing belt 22 wound thereon at the time of switch-over between normal and reverse rotations of the impression cylinder 6 an impact force develops which tends to cause a momentary slip to occur, assisted by backlash at an area where the timing pulley 15 and the timing belt 22 engage with each other and by elasticity of the timing belt. As a result, continuous paper 10 each time its traveling direction is switched is adversely affected such as by its fluttering.

However, with the impression cylinder 6 provided with the driving pulley 16 juxtaposed, on which is wound the V belt 23 wound on the V pulleys 18a and 18b fastened to the guide rollers 14a and 14b, the frictional driving force which this belt creates causes the slip occurring between the timing pulley 15 and the timing belt 23 to be absorbed and relieved, thereby inhibiting continuous paper 10 from fluttering each time its travel direction is switched.

While it is required that the timing pulleys 15, 17a, 17b, 19a, 19b and the V pulleys 16, 18a, 18b, 20a, 20b be identical in their pitch circle diameters as for their respective axes, as a matter of fact a machining error of each of these pulleys makes it difficult to make them identical in their pitch circle diameters.

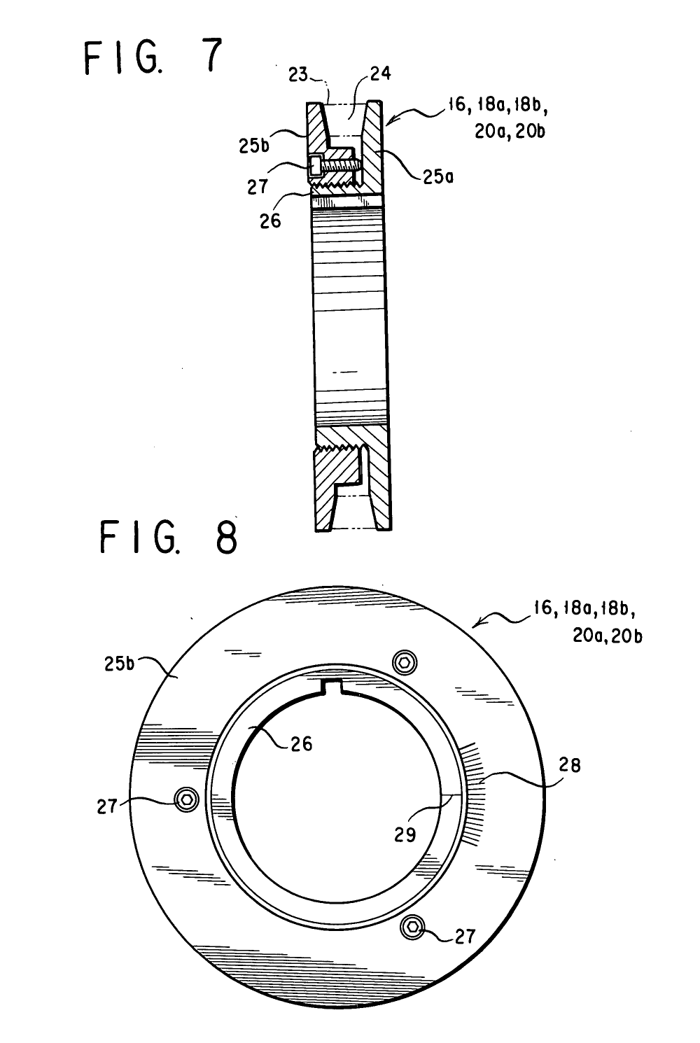

For this reason, the V pulleys 16, 18a, 18b, 20a and 20b are made as shown in FIGS. 7 and 8 so that their groove widths are adjustable. To wit, one groove wall member 25a and the other groove wall member 35b which together form a V groove 24 are made axially separate, and the one groove wall member 25a has a boss 26 with which the other groove wall member 25b is coupled by thread engagement so that the depth of thread engagement makes the width of the V groove 34 adjustable. And, the one groove wall member 25a is made fixable to its shaft and the other groove wall member 25b is made manually rotatable relative to the boss 26 of the one groove wall member 25a and has set screws 27 for fastening the other groove wall member 25b to the one grove wall member 25a. The other groove wall member 25b made rotatable is formed on a surface thereof with graduations 28 circumferentially, whose position relative to a reference graduation 29 formed on an end face of the boss 26 of the one groove wall member 25a indicates a width of the V groove 24 adjusted for adjustment of a pitch circle diameter of the groove.

While in the form of implementation shown in FIG. 4, the timing and V pulleys are shown provided adjacent to one end side of the impression cylinder 6 and the guide rollers 14a and 14b, they may be provided as axially spaced apart with the timing pulley at one end and the V pulley at the other end axially.

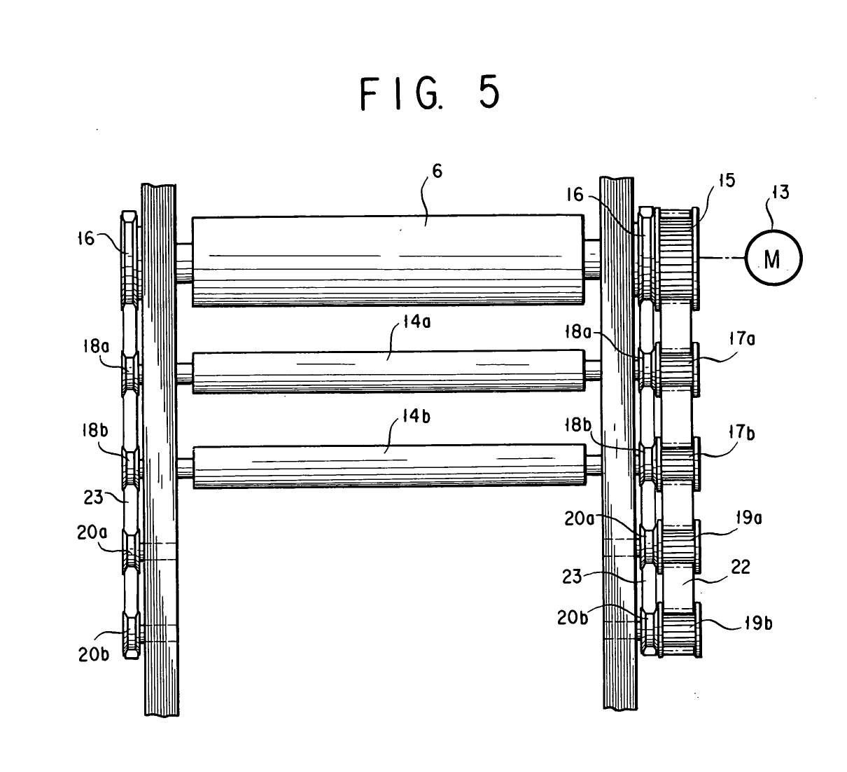

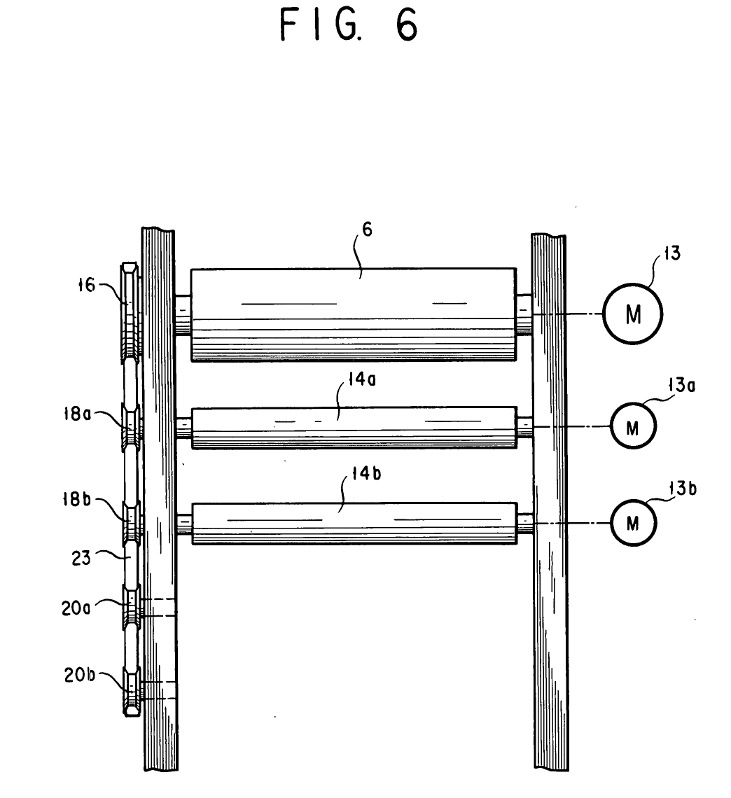

FIGS. 5 and 6 show alternative forms of implementation of the present invention. In the form of implementation shown in FIG. 5, the impression cylinder 6 and the guide rollers 14a and 14b are provided at their axially one end side with timing pulleys 15, 17a, 17b, 19a and 19b, V pulleys 16, 18a and 18b and tension V pulleys 20a and 20b and at their axially other end side also with V pulleys 16, 18a and 18b and tension pulleys 20a and 20b that are identical to those at the one end side and on which a V belt 23 is wound.

In this alternative form of implementation, the guide rollers 14a and 14b are driven by the parallel V belts at axially both ends and being especially fine in diameter are thereby kept from behavior of becoming twisted so as to allow continuous paper to run stably through a region of these guide rollers.

In the form of implementation shown in FIG. 6, in addition to the impression cylinder 6 driven by the motor 13, the guide rollers 14a and 14b are driven by motors 13a and 13b, respectively, which are controllably rotated. Also, the impression cylinder 6 and the guide rollers 14a and 14b are provided at their respective sides opposite to the motor sides with V pulleys 16, 18a and 18b and tension V pulleys 20a and 20b which are like those shown in FIG. 5.

According to this form of implementation, the guide rollers 14a and 14b as well as the impression cylinder 6 are motor-driven individually, with motors 13a and 13b while they at their other end side are rotationally driven without becoming twisted by the V belt 23. And, in this form of implementation, guide rollers which besides guide rollers 14a and 14b for each printing unit 3a, 3b, 3c, 3d include guide rollers 14c and 14d provided, respectively, at the downstream side of the upstream side feed roller 1 and at the upstream side of the down-stream side feed roller 2 as shown in FIG. 2 and possible other guide rollers, namely all the guide rollers provided between the two feed rollers 1 and 2 may all be individually driven by their respective motors 13 which are controllably rotated independently.

While in the forms of implementation mentioned above the printing units 3a to 3d are described as being of offset type, suffice it to say that each of them may be of direct printing type without using the blanket cylinder.

Also, in the forms of implementation mentioned above, the guide roller means may not necessarily be two guide rollers 14a and 14b which are used at the upstream and downstream sides of an impression cylinder 6, respectively. What is essential is its capability of winding continuous paper 10 on the impression cylinder 6 and it may be provided at one of the sides.

Further, each of the printing units 3a to 3d may as shown in FIG. 2 be provided with a dryer 28 such as an UV dryer at the down-stream side of the impression cylinder 6 so that an image directly after printing by each printing unit 3a, 3b, 3c, 3d can be dried.

What is claimed is:

1. A variable printing machine having a pair of feed rollers synchronously rotatable normally and reversely and at least one printing unit arranged between the feed rollers wherein the printing unit includes a printing and an impression cylinder continuously rotatable while passing between them printable continuous material fed by the feed rollers to travel, and the printing cylinder is formed on its periphery with a larger diameter section adapted for contact with the printable material between the printing and impression cylinders to print on the printable material and a smaller diameter section not contactable with the printable material whereby the feed rollers act to cause the printable material to travel at a speed equal to a speed of rotation of the larger diameter section while the larger diameter section of the printing cylinder is in contact with the printable material and then to cause the printable material to travel reversely by a portion corresponding to non-image bounds in the larger diameter section of the printing cylinder while the smaller diameter section is opposed to the printable material, characterized in that:
said impression cylinder in the printing unit is adapted be driven to rotate synchronously with said pair of feed rollers; and
there are further provided:
guide roller means at least at one of upstream and down-stream sides of said impression cylinder by which the printing material to pass between the printing cylinder and impression cylinders is wound at a certain angle of winding on said impression cylinder;
on said impression cylinder a timing and a V pulley which are identical in pitch circle diameter to each other and on said guide roller means a timing and a V pulley which are identical in pitch circle diameter to each other, wherein said timing and V pulleys provided on said impression cylinder and those provided on said guide roller means have a ratio between their pitch circle diameters which is identical to a ratio between the outer diameters of said impression cylinder and said guide roller means; and
a timing belt and a V belt adapted to be wound on said timing pulleys and said V pulleys, respectively, and driven to rotate said guide roller means at a peripheral speed identical to that of, and synchronously with, said impression cylinder.

2. A variable printing machine as set forth in claim 1, characterized in that in addition to the V pulleys provided together with the timing pulleys at one ends of said impression cylinder and guide roller means, further V pulleys are provided on the other ends of the impression cylinder and guide roller means, and a further V belt is wound on said further V pulleys.

3. A variable printing machine having a pair of feed rollers synchronously rotatable normally and reversely and at least one printing unit arranged between the feed rollers wherein the printing unit includes a printing and an impression cylinder continuously rotatable while passing between them printable continuous material fed by the feed rollers to travel, and the printing cylinder is formed on its periphery with a larger diameter section adapted for contact with the printable material between the printing and impression cylinders to print on the printable material and a smaller diameter section not contactable with the printable material whereby the feed rollers act to cause the printable material to travel at a speed equal to a speed of rotation of the larger diameter section while the larger diameter section of the printing cylinder is in contact with the printable material and then to cause the printable material to travel reversely by a portion corresponding to non-image bounds in the larger diameter section of the printing cylinder while the smaller diameter section is opposed to the printable material, characterized in that:
said impression cylinder in the printing unit is adapted to be driven to rotate synchronously with said pair of feed rollers; and
there are further provided:
guide roller means at least at one of upstream and down-stream sides of said impression cylinder by which the printing material to pass between said printing cylinder and impression cylinders is wound at a certain angle of winding on said impression cylinder; and
a motor means coupled individually to each of said impression cylinder and said guide roller means at one end thereof, said motor means having a motor whose rotation is controllable independently.

4. A variable printing machine as set forth in claim 3, characterized in that said impression cylinder and said guide roller means have at their other ends V pulleys fastened thereto, respectively, whose ratio between their pitch circle diameters is identical to a ratio between the outer diameters of said impression cylinder and guide roller means and a V belt is wound on said V pulleys.

5. A variable printing machine as set forth in claim 4, characterized in that all said guide roller means provided between said pair of feed rollers are adapted to be driven individually by respective motors whose rotation is controllable independently.

6. A variable printing machine as set forth in claim 1, characterized in that all said guide roller means provided between said pair of feed rollers are adapted to be driven individually by respective motors whose rotation is controllable independently.

7. A variable printing machine as set forth in claim 2, characterized in that all said guide roller means provided between said pair of feed rollers are adapted to be driven individually by respective motors whose rotation is controllable independently.

8. A variable printing machine as set forth in claim 3, characterized in that all said guide roller means provided between said pair of feed rollers are adapted to be driven individually by respective motors whose rotation is controllable independently.
